(19) United States
(12) Patent Application Publication
(10) Pub. No.: US 2023/0316653 A1
(43) Pub. Date: Oct. 5, 2023

(54) Adaptive Chunk Navmesh Generator

(71) Applicants: John A. Halsema, Vienna, VA (US); Christopher A. Guryan, Vienna, VA (US); Bradford Sims Robnett, Vienna, VA (US)

(72) Inventors: John A. Halsema, Vienna, VA (US); Christopher A. Guryan, Vienna, VA (US); Bradford Sims Robnett, Vienna, VA (US)

(21) Appl. No.: 17/947,367

(22) Filed: Sep. 19, 2022

Related U.S. Application Data
(60) Provisional application No. 63/245,252, filed on Sep. 17, 2021.

(51) Int. Cl. G06T 17/20; G06T 19/00

(52) U.S. Cl. CPC G06T 17/205; G06T 19/003

(57) ABSTRACT

The present disclosure provides a method of creating a navigational mesh comprising: establishing the required dimensions for the navmesh and the chunks therein, determining the minimum and maximum x and y values of each minimal sized chunk that together comprise the site within the navigational mesh, determining what is present within the navmesh, such as roads and bodies of water, creating a navmesh section corresponding to the site dimensions subdivided in the previous steps, and stitching neighboring edges together to create a single contiguous mesh that covers the entire site.

### CROSS REFERENCE TO RELATED APPLICATIONS

This application claims priority to, and the benefit of, pending U.S. Provisional Application No. 63/245,252 filed Sep. 17, 2021.

### BACKGROUND

Navigation meshes (“navmesh”) are known in the prior art. Navmeshes are generally composed of a plurality of polygons overlaid onto an area to be mapped. Prior art solutions employ a series of processes that identify walkable surfaces and fixed obstacles in a 3D model and then generate an interconnected set of polygons that can then be used by a pathfinding method to find navigable paths through the site model. Navmeshes are most commonly used today in gaming and haven’t been adopted or adapted for long range optimized uses. The instant application solves the short comings known in the prior art.

### DETAILED DESCRIPTION

The instant application discloses a unique and novel method of generating a navmesh for useful with security and planning software such as AVERT®. In one embodiment, the process generally comprises the steps of:
1. Establishing the required dimensions for the navmesh and the chunks therein;
2. Determining the minimum and maximum x and y values of each minimal sized chunk that together comprise the site;
3. Determining what is present within the navmesh, such as roads and bodies of water;
4. Using multiple processing threads running in parallel, feeding each navmesh section into a customized version of NMGen which creates a navmesh section corresponding to the site dimensions subdivided in the previous steps; and
5. Stitching neighboring edges together to create a single contiguous mesh that covers the entire site.

In this embodiment, step 1 is a necessary precursor to subdividing the site model into regions for navmesh processing. The minimum and maximum horizontal coordinates, plus an edge overlap fitting the site subdivision to a whole number of chunk spans, determines the horizontal site dimensions. Vertical dimensions represent actual site elevation above sea level and are typically in meters.

In step 2 in this embodiment, a minimal chunk size is set to a fixed value of 30 meters across; this value was determined after experimentation with a large number of models representing different sizes, from tens to tens of millions of square meters. Then which terrain types exist within each chunk are determined which establishes a minimal voxel granularity for the chunk based on the known library settings for the terrain types found in the chunk. Each chunk is also evaluated for the presence of either barriers or the edges of detector volumes which in order to preserve precision for both navigation and the heatmaps, force the granularity to no greater than a fixed level.

In step 3 of this embodiment, large bodies of water in the site model are modeled as completely flat and use the largest granularity value of 2 meters. Large expanses of relatively flat terrain are typically assigned terrains with a granularity value of one meter. Roads and walls typically get a value of 0.5 meter, and spaces inside building generally get a value of 0.2 meter. A use can set or override these values through a library that specifies navmesh granularity based on terrain type. Neighboring quads of high granularity chunks are combined into a single larger navmesh section with two times the x and y dimensions. These larger sections are then checked to see whether all their immediate neighbors can form a quad that is another two times larger in each dimension. This process is repeated several times to relax granularity restrictions where high precision is less important that processing time and memory resources.

In step 5 of this embodiment, once all the navmesh sections have been created and stitched, the resulting mesh for a typical user site is so large that complex paths across the site take from seconds to potentially minutes to calculate. Such path calculation times are far too slow to be of any value to game engines, which value fast calculation and a superficial illusion of pathfinding depth over a more rigorous, optimal path within specified constraints.

Overall, the present solution provides several advantages over the prior art, including:
Automatically determining the dimensions of the voxels and navmesh chunks to use in generating different parts of the composite navmesh and using the features local to the various parts of the site map, including types of terrain, the presence of barriers or fixed detector region boundaries, to dynamically scale both the voxel size and the dimensions of the chunks in those regions. This allows the minimization of memory usage and navmesh generation time while also generating larger navmesh cells in expansive regions where fine detail is not required.
Combining the navmesh surfaces with navigable volumes and automatically generates connections between them.
The use of automatically determined variable-sized voxels and chunks in generating sections of a navmesh allows significant optimization of system memory and generation time. It also allows for generally larger navmesh cells in areas where less pathfinding detail is required while preserving the highest detail in complex spaces where it is more critical. Automatic connections between navigable surfaces and volumes gives users the ability to configure scenarios involving agents and vehicles that move differently in different regions, or which may be entirely unable to move in certain regions.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated. As used herein, the singular forms “a”, “an” and “the” are intended to include the plural forms as well, unless the context clearly indicates otherwise.

Although particular embodiments of the present disclosure have been described, it is not intended that such references be construed as limitations upon the scope of this disclosure except as set forth in the claims.

We claim:

1. A method of creating a navigational mesh comprising:
a. establishing the required dimensions for the navmesh and the chunks therein;
b. determining the minimum and maximum x and y values of each minimal sized chunk that together comprise the site within the navigational mesh;
c. determining what is present within the navmesh, such as roads and bodies of water;
d. creating a navmesh section corresponding to the site dimensions subdivided in the previous steps; and
e. stitching neighboring edges together to create a single contiguous mesh that covers the entire site.

2. The method of claim 1 wherein step d. further comprises running multiple threads in parallel.

3. The method of claim 1 wherein step a. further comprises determining the horizontal dimensions of the navigational mesh.

4. The method of claim 3 wherein step a. further comprises using at least one of determining the minimum and maximum horizontal coordinates or an edge overlap fitting the site subdivision to a whole number of chunk spans.

5. The method of claim 3 wherein step a. further comprises determining the vertical dimensions of the navigational mesh.

6. The method of claim 5 wherein step b. further comprises determining a minimal voxel granularity within each chunk.

7. The method of claim 2 wherein step b. further comprises determining a minimal voxel granularity within each chunk.

8. The method of claim 3 wherein step b. further comprises determining a minimal voxel granularity within each chunk.
